(19) United States
(12) Patent Application Publication
(10) Pub. No.: US 2006/0141997 A1
(43) Pub. Date: Jun. 29, 2006

(54) System and method for remote controlling equipment with the aid of api functions, and corresponding device, radiocommunication module, and set of functions

(76) Inventor: Christian Amiens, Gourbeyre (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/561,114

(22) PCT Filed: Jun. 16, 2004
(86) PCT No.: PCT/FR04/01498

§ 371 Date: Dec. 16, 2005

(30) Foreign Application Priority Data
Jun. 16, 2003 (FR) 03/07239

(51) Int. Cl. H04M 3/00

(52) U.S. Cl. 455/418

(57) ABSTRACT

The disclosure relates to a system for remote controlling equipment, which allows at least one server and at least one remote piece of equipment to be interconnected according to the MQIsdp protocol. Said system associates radiocommunication means with at least one of said remote pieces of equipment in order to internally process a communication protocol that uses API-type source functions which are available on a software platform (open AT) allowing at least one application to be hosted. Said radiocommunication means are provided with a set of specific (API) functions in order to exchange data with at least one server that uses said MQIsdp protocol such that said server/s and said remote piece/s of equipment can be interconnected via said radiocommunication means which also manage at least one application located between the server/s and the remote piece/s of equipment.

This invention relates to the field of remote control of apparatus, and in particular apparatus with limited data processing resources. Thus, the invention applies, for example, to systems for remote data reading, for example, water, gas or electric meters, and more generally telemetry system and order tracking systems, and more generally, machine to machine (M to M) systems.

There is already a variety of solutions for performing such operations. They have generally been developed specifically for a given application. In other words, these are “proprietary” solutions, which are difficult to adapt to other applications.

In addition, a protocol developed by the IBM and ARCOM Control Systems companies (registered trademarks), is known as “MQIsdp Messaging”. This technique provides a protocol for communication between one or more apparatuses with limited resources, and one or more brokers, using a TCP/IP connection.

However, even with this specific protocol, it is necessary to add specific processing means to the apparatus (microprocessors, memories, etc.) that enable the dialogue with these remote brokers to be initiated according to the MQIsdp format required. The connection between the apparatus and the broker can use a telephone-type connection with a modem.

In many applications, however, it would not be desirable to be capable of connecting via a cable telephone link. In this case, the use of radiocommunication means, for example according to the GSM or GPRS standard, can be considered.

In this case, radiotelephony apparatus for providing the modem function is used. However, it remains necessary, according to the prior art, to associate specific and proprietary data processing means with the equipment in order to establish and carry out the exchange of data with the broker.

This aspect is a major limitation to the development of the applications mentioned above, and many other application that can be considered with the MQIsdp protocol.

The aim of the invention is, in particular, to overcome this disadvantage of the prior art.

It should be noted that the identification of this problem is, in itself, a part of the invention. Indeed, a person skilled in the art is convinced that it is absolutely necessary to equip terminal apparatus with adequate processing means, and can in no case imagine that it is possible to reduce them, or even eliminate them.

Nevertheless, it is an aim of the invention to reduce the processing necessary for the apparatus, and to prevent the latter from being equipped with complex and costly means such as a microprocessor.

Another aim of the invention is to propose a simple and general technique, enabling a dialogue with a broker to be initiated easily and effectively, according to the MQIsdp protocol.

Thus, a particular objective of the invention is to enable such a dialogue to take place simply and inexpensively, using a simple radiocommunication module.

Another aim of the invention is to provide such a technique enabling a connection to be established between brokers and apparatus via a radiotelephone channel, in a simple, standardised and inexpensive manner.

The invention also aims to provide such a technique enabling a large number of applications to be developed, without the need to develop specific applications each time.

Another aim of the invention is to provide such a technique not requiring knowledge of the MQIsdp protocol in the applications developed.

Yet another aim of the invention is to provide such a technique which is both technically simple and open-ended, and capable of being adapted to various situations (for example, for the size of the data to be exchanged) and to possible future changes.

These objectives, as well as others that will become more clear below, are achieved according to the invention with a system for remote control of apparatus enabling an interconnection between at least one broker and at least one remote apparatus according to the MQIsdp protocol.

According to the invention, the control system associates, with at least one of said remote apparatuses, radiocommunication means capable of internally processing a communication protocol implementing API-type source functions available in a software platform (Open AT) enabling at least one application to be embedded, and said radiocommunication means are provided with a set of specific (API) functions enabling data to be exchanged with at least one broker implementing said MQIsdp protocol, so as to enable an interconnection between the broker(s) and the remote apparatus(es) via said radiocommunication means, the latter also managing at least one application between the broker(s) and the remote apparatus(es).

Thus, it is possible to entirely internally manage, in the radiocommunication means, and in particular in a module, the application for controlling one or more terminals with a broker functioning according to the MQIsdp protocol, without the terminal knowing this protocol. There is nothing to add to the terminal (no equipment, such as a microprocessor or memory, or software, such as a dedicated application). This is the module that manages these operations, by means of the functions of the invention, and provides the interface with the MQIsdp protocol.

According to an advantageous embodiment, said radiocommunication means include a radiocommunication module, combining on a single substrate, all of the radiofrequency and baseband data processing means, as well as the means for managing said (API) functions and said application(s). This is the module that integrates the application and the source (API) functions.

Preferably, said radiocommunication means integrate said MQIsdp protocol in the form of a library, defining said set of specific (API) functions.

At least in a first embodiment, said radiocommunication means manage only the signalling of a data exchange, and said data is transferred directly from a remote apparatus to a broker, or the reverse.

In a second advantageous embodiment, which is the one currently being developed, said radiocommunication means manage the signalling of a data exchange and the transfer of said data, with the latter being temporarily stored in at least one buffer storage.

In this case, the size of said buffer storage(s) is advantageously parameterable.

If both embodiments are available, it is preferable to work in said first embodiment when the size of said buffer storage(s) is 0, and in said second embodiment if not.

Advantageously, said set of API functions includes functions enabling:
the connection to one of said brokers;
the sending of messages;
the receiving of messages;
configuration of at least one parameter.

Preferably, at least some of said specific (API) functions are organised so as to be capable of providing at least two operations and/or acting on at least two distinct aspects, according to a predefined parameterisation.

This enables the number of functions to be optimised, while making changes possible.

In a preferred embodiment, said set of (API) functions includes only 12 functions.

Advantageously, said set of specific (API) functions includes an initialisation function (mqisdp_init) restoring default parameters, which must be called at least once before the use of other (API) functions.

Preferably, said set of specific (API) functions includes a function (mqisdp_resume) called when an IP connection has been established.

Advantageously, it includes a function of establishing a connection with one of said brokers (mqisdp_connect), enabling parameters of said connection to be defined, and a function of disconnecting (mqisdp_disconnect) said connection.

Said function of establishing a connection advantageously enables, in particular, a transmission mode to be selected from at least two (GSM and GPRS).

Said set of functions also advantageously includes a function (mqisdp_publish) for sending a message to one of said brokers.

Preferably, it includes a function of subscribing to one of said brokers (mqisdp_subscribe), and a function of unsubscribing (mqisdp_unsubscribe) to said broker.

Advantageously, said set of functions includes at least one function for requesting information on at least one aspect of a communication in progress, and, for example, at least one of the functions belonging to the group including:
a function for inquiring about the status of a connection (mqisdp_getConStatus);
a function for inquiring about the status of a given message (mqisdp_getMsgStatus);
a function for inquiring about the current size of a queue (mqisdp_geQueueSize);
a function for inquiring about the space available in a queue (mqisdp_getAvailableSize).

Preferably, it includes a function for defining the size of a queue (mqisdp_setQueueSize).

The invention also relates to methods for remote control apparatuses, enabling the interconnection between at least one broker and at least one remote apparatus according to the MQIsdp protocol.

Such a method associates, with at least one of said remote apparatuses, radiocommunication means capable of internally processing a communication protocol implementing API-type source functions available in a software platform (Open AT) enabling at least one application to be loaded, and implements, in said radiocommunication means, a set of specific API functions enabling data to be exchanged with at least one broker implementing said MQIsdp protocol, so as to enable an interconnection between said broker(s) and said remote apparatus(es) via said radiocommunication means, wherein the latter also manage at least one application between said broker(s) and said remote apparatus(es).

The invention also relates to radiocommunication devices and modules implemented in a system for remote control of apparatuses as described above.

Finally, the invention also relates to a set of (API) functions implemented in a system for remote control of apparatuses, enabling data to be exchanged with at least one broker implementing said MQIsdp protocol.

Other features and advantages of the invention will become more clear from the following description of a preferred embodiment of the invention, given as a simple illustrative and non-limiting example, and the appended drawings, in which:

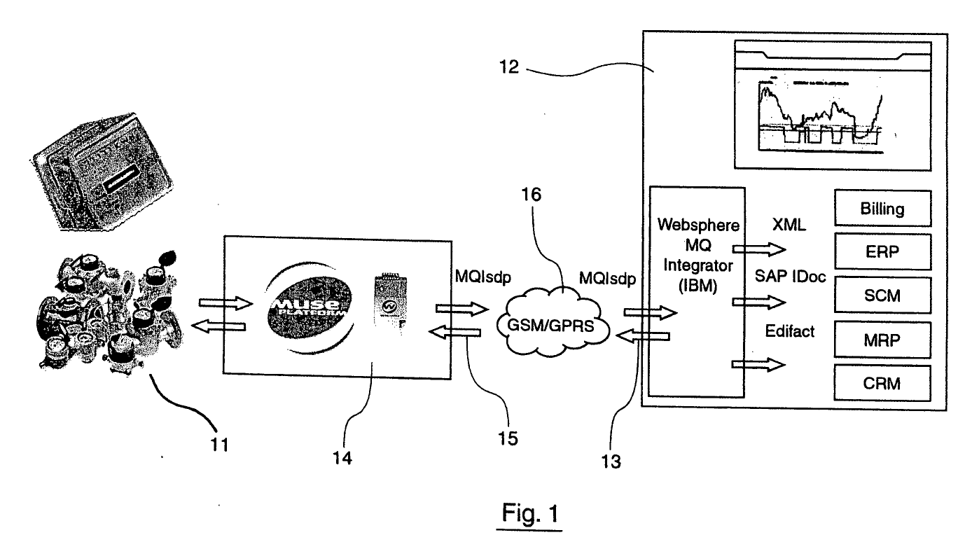

FIG. 1 shows an example of a system in which the invention can be implemented;

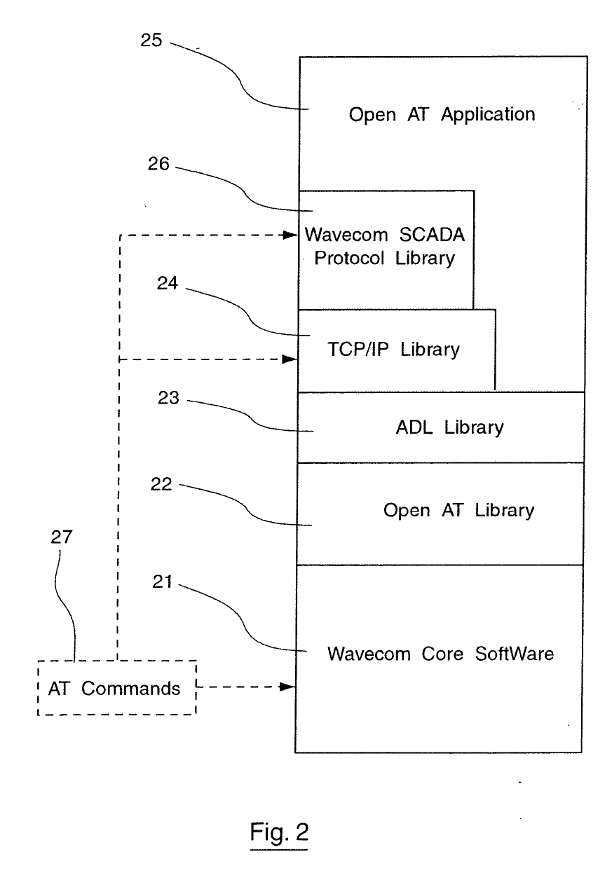

FIG. 2 is an example of integrating the MQIsdp protocol in a module according to the invention;

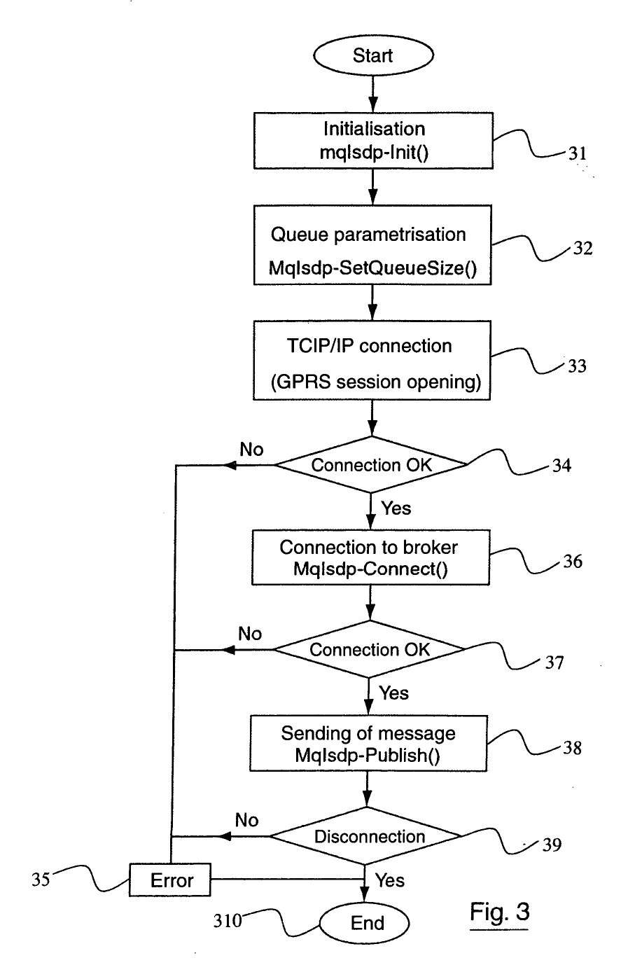

FIG. 3 is a simplified diagram of an example of sending a message by means of the invention.

1) Summary of the MOIsdp Protocol (Registered Trademark)

The MQIsdp protocol (“WebSphere MQ Integrator SCADA device protocol”) is an open standard developed by IBM and Arcom Control Systems (registered trademarks), intended to enable the exchange of data (in the form of messages) from remote devices (or terminals), generally low-end and having little processing power, to a broker, WebSphere MQ Integrator, by TCP/IP, and the reverse.

MQIsdp (also referred to as Wavecom SCADA) is a data (message) transfer protocol based on a publish/subscribe-type communication model available copyright free on the Internet. It can be described as a simple agnostic data management layer above the TCP/IP protocol for providing management and acknowledgements of message receipt required for ensuring reliable delivery of the message.

In the publish/subscribe communication model, the data is exchanged between a data producer/consumer (the client) and a message broker. The message broker can be considered to be a “hub” for multiprotocol switching at the level of the protocol of the application that receives, transforms and reformats messages, and so on, into other structures according to a data model defined by the user.

Finally, the messages optionally transformed can be sent by the broker (published) to subscribing clients (zone device, ERP, SAP, Oracle, SQL, etc.) by using appropriate client cards. The broker can obviously also publish messages not coming from a client.

The message broker manages all incoming and outgoing messages of a header. A client publishes messages in/with a header or subscribes to messages from/by a header identifying the message flow of the message broker to which or from which the message must be published.

The MQIsdp specification defines a set of very simple messages, including: connect, disconnect, publish, subscribe, unsubscribe.

2) Principles of the Invention

2.1) General

The invention therefore relates to a new approach for remote control of apparatuses, in particular based on the implementation of a set of specific API functions enabling an external application to manage data exchanges between a remote terminal and a broker, via radiocommunication means (for example, a Wismo module (registered trademark)), without the application knowing the MQIsdp protocol implemented by the broker. These radiocommunication means manage this aspect, and, for example, the acknowledgements provided in the MQIsdp protocol.

The API functions are functions developed in C language, which enable the module to internally manage, under the control of an application which is also internal to the module, data exchanges with brokers implementing the MQIsdp protocol.

FIG. 1 is a simplified illustration of the principle of the invention. The objective is to enable communication between any type of remote machine, for example, measuring instruments 11 and one or more applications hosted by brokers 12, capable of receiving data 13 according to the MQIsdp protocol, and of transforming, processing or transmitting it.

According to the invention, radiocommunication means 14 are associated with the remote terminals (or machines) 11, which radiocommunication means are, for example, in the form of a Wismo module (registered trademark), in particular loading the development tools distributed by the applicant under the trademark “Muse platform”.

2.2) Module Concept

It is necessary to remember that most radiocommunication devices conventionally include a set of electronic components implanted on a printed circuit. These different components are intended to provide the various functions necessary, from receiving a RF signal to generating an audible signal (in the case of a radio-telephone), and the reverse. Some of these functions are analogue, and others are digital.

The production of these radiocommunication devices is a significant topic of research. Indeed, there are at least three difficult objectives to be achieved: miniaturising the devices, increasing the functionalities, and simplifying the assembly. It is known in particular that the implantation of the various components on the printed circuit is a relatively complex operation, as many components must be positioned on a surface that is becoming smaller and smaller, due to the miniaturisation requirements.

The design of these systems is therefore complex, since it also requires combining various components, often from multiple sources, that must be made to work together, while respecting the specific characteristics of each one. Moreover, after assembling all of the components, calibration and test phases, which are often time-consuming and complex, are necessary in order to ensure that the device functions properly.

Finally, in spite of the reduced size of some components, the assembly occupies a surface space that is difficult to reduce.

The holder of this patent application has proposed an approach enabling a number of these disadvantages to be overcome, consisting of combining, in a single module, all or at least most of the functions of a digital radiocommunication device.

Such a module is in the form of a single and compact casing, preferably shielded, which the device manufacturers can implant directly, without having to take into account a plurality of components.

This module (also sometimes referred to as a “macrocomponent”) is indeed formed by a group of several components on a substrate, so as to be implanted in the form of a single element. It includes the essential components and software necessary for the operation of a telecommunication terminal using radio-electric frequencies. Therefore, there are no more complex design and validation steps. It is simply necessary to reserve the space needed for the module.

Such a module therefore makes it possible to integrate, easily, rapidly and in an optimised manner, all of the components in wireless terminals (portable telephones, modems, or any other application running on a wireless standard).

In addition, as it groups all of the essential functions together and has been designed as a whole, the problems of calibration and tests no longer arise in the same way, or are at least substantially simplified.

Thus, the modules distributed by the holder of this patent application have been entirely tested at the level of both hardware and software on most of the networks on which they can subsequently be used. Moreover, the module advantageously includes the aspects of industrial property (as all of the functions have been grouped together, it is the manufacturer of the module who manages the corresponding aspects of industrial property rights) and technical assistance.

2.3) API Functions

Modules with APL functions are already known. Patent document FR-0103909 thus presents a radiocommunication module that hosts and runs a main software program in particular providing radiocommunication functions, which main software program includes means for executing control commands, sent to the main software by at least one client control software and belonging to a predetermined set of control commands.

According to this technique, the radiocommunication module also hosts and runs at least one client software, referred to as embedded client software. In addition, the embedded software and the main software include means enabling the embedded client software to play at least one of the two following roles:
the role of client control software, sending control commands to the main software, and receiving from the main software responses, resulting from the execution of certain control commands;
the role of a client monitoring software, managing the execution of control commands sent by a client control software, referred to as an external client software, hosted and run by a third party apparatus cooperating with the radiocommunication module.

The general principle of the invention therefore consists of hosting on the radiocommunication module at least one client software capable of playing the role of a client control software and/or the role of a client monitoring software.

Reference can be made to this document for more details, if necessary.

2.4) New API Functions

Module 14 is therefore capable, according to the invention, of managing API functions, and, in a limited number, enabling a simple and effective dialogue with a terminal, under the control of an internal application. It ensures the transformation to the MQIsdp format, and manages the transmission and reception of data 15 according to this protocol, in a transparent manner for the application and the terminal.

The exchange of data can thus be performed in a hertzian manner 16, for example, according to the GSM or GPRS standard. From the broker 12, the data is in MQIsdp format. It is not necessary for the terminals to know this protocol, or to implement specific means, such as a microprocessor and memory, and a dedicated application.

As will be seen below, there may be a limited number of proposed functions, while allowing for changes.

The data goes through module 14. It is then temporarily stored in buffers, of which the size can be configured as needed.

FIG. 2 shows a simplified example of software architecture capable of being implemented in module 14.

Such a module 14 generally includes:
a basic software layer 21 (Wavecom Core SoftWare);
an Open AT library 22 (“Open AT Library”);
an ADL library 23 (“ADL Library”);
a TCP/IP library 24 (“TCP/IP Library”);
an application layer 25 (“Open AT Application”).

According to the invention, a specific command library 26 (“Wavecom SCADA Protocol Library”) is provided to communicate according to the MQIsdp protocol, which is placed at the level of the TCP/IP library 24.

The proposed interface includes, in this library 26, only 12 API functions, enabling full exploitation of the MQIsdp protocol. These functions are described in detail below.

Optionally, the AT commands 27 are addressed, as the case may be, to the basic layer 21, to the TCP/IP library 24 or to the SCADA library 26. The module can indeed also manage AT commands, in order to provide the same interface operations.

3 Detailed Description of an Embodiment of API Functions

API functions capable of being used to control the Wavecom SCADA protocol 26 are described below.

3.1) Related Documents

Reference can be made, as needed, to:

[1] “WebSphere MQ Integrator SCADA Device Protocol”, which appears in appendix B of the reference manual “IBM WebSphere MQ Integrator Programming Guide” available at the following address: http://publifp.boulder.ibm.com/epubs/odf/bipyal04.pdf
[2] Wavecom AT Commands Interface Guide
   Reference: WM_SW_OAT_IFS_{—}001-revision: 009 and following.
This document describes the AT commands implemented by the Wavecom product enabling the management of events or related GSM services.
[3] AT Command Interface for TCP/IP
Revision: 1.7
This document describes the parameters and the set of AT commands enabling the configuration and control of the overlay of TCP/IP and protocols available on Wavecom products.
[4] WebSphere MQ Integrator Programming Guide (Version 2.1), Appendix B.
[5] Edjlb-30x Interface Specification
[6] ADL User Guide
   3.2) Abbreviations and Definitions
   3.2.1) Abbreviations
   MQIsdp MQ Integrator SCADA device protocol
   SCADA Supervisory Control and Data Acquisition
   APN Access Point Name
   AT Attention
   DNS Domain Name System
   ISP Internet Service Provider
   ME Mobile Equipment
   MS Mobile Station
   QoS Quality of Service
   3.3) Architecture

The MQIsdp library is constructed above the ADL Wavecom library and the TCP/IP library. Interleaved applications using the MQIsdp library must therefore be implemented using the ADL library (rather than directly with the standard API Open AT layer).

FIG. 2, mentioned above, has this architecture.

The “MQIsdp for Open AT” software according to this embodiment contains the following elements:
A software library consistent with ADL (wmmqisdp.lib)
A header file (mqisdp.h) defining the API MQIsdp
Several source code samples

An interleaved application using the MQIsdp library must be connected to wmadi.lib and edlib.lib (these libraries are included in the software “MQIsdp for Open AT” provided with the module).

3.4) Remarks on Memory Management

Owing to the limited memory resources in the Open AT environment, it is important to know the exact amount of memory used by a library or a given process. The MQIsdp library is therefore centred around a precise management of the memory.

All of the MQIsdp command functions in the API application (connect, publish, subscribe, unsubscribe and disconnect) are asynchronous (the functions immediately return and the final output of the associated operations is signalled by recall).

At any time, there may be MQIsdp messages that the library has accepted, but that have not been sent to the broker, which have not yet received acknowledgement of receipt from the broker or which have not yet been distributed to the interleaved application (the client). All of these pending messages are retained in the queue by the library. The library cannot guarantee the maximum size of this queue because it depends on the size of the data to be sent/received, the sending/receiving frequency and the bandwidth of the TCP/IP connection.

Complete control of the maximum size of the queue is provided to the client application by a set of API functions enabling the maximum size of the queue to be defined and known and the current size of the queue to be asked.

In some cases (high rate of transmission errors leading to frequent connection failures), a greater size of the queue is necessary because the library must put the messages in buffer storage until the communication has been restored.

3.5) Additional Remarks

3.5.1) Only One MOIsdp Connection at a Time

The MQIsdp library is dependent on the TCP/IP library, which is limited to one connection at a time. The MQIsdp library is therefore limited to only one MQIsdp connection at a time.

3.5.2) Limited MOIsdp Message Size

The library can be designed to send and receive MQIsdp messages with a maximum size of 65 535 octets (including fixed and variable headers).

The MQIsdp specification allows for maximum payload lengths of 268 435 455 octets, which means that a broker can potentially send a message larger than 65 535 octets (or the maximum size of the queue) to the client. In this case, the client is warned by a processing program that the queue is full (and the message is not received). Similarly, if the client tries to send messages when the queue is full, a signal will indicate that the queue is full and that the sending of the message has not been accepted.

It is thus easy to manage a queue that may be full and/or the transmission of a message that is too large.

As already mentioned, it is also possible, in some embodiments, to provide direct transfers between a terminal and the broker, with the module managing only the signalling.

3.6) API MOIsdp

The following sections provide a detailed description of all of the functions of the API MQIsdp.

3.6.1) Required Header

The header of the MQIsdp functions is: Mqisdp.h

3.6.2) MOISDP Init Function

This function absolutely must be called in order to initialise the MQIsdp library; it must be called at least once before the use of other API functions.

The function restores (or reinitialises) the default values of the connection parameters and the connection options. It adjusts the size of the queue on 3 Ko. If the function is called when a connection is active, it will suddenly disconnect and delete all of the messages in the queue.

The TCP/IP library absolutely must be initialised before the initialisation of the MQIsdp library.

a—Prototype

u8 mqisdp_init (mqisdp_linkHdlr_f LinkHandler);

b—Parameters

* LinkHandler:

The LinkHandler parameter is called by the library when an IP connection is necessary but absent or when the IP connection is present but unnecessary. It therefore enables the client application to precisely control the IP connection.

The following type is used for the LinkHandler parameter:

typedef void (*mqisdp_linkHdlr_f)(u8 Event);

The Event parameter can be:
MQISDP_LINK_NEEDED if an IP connection is necessary, but not connection has been established.
MQISDP_LINK_CLOSABLE if an IP connection is no longer necessary but a connection is established.

The caller can either provide a LinkHandler parameter consistent with the prototype below, or use NULL. If the LinkHandler parameter is NULL, the library will provide the control of the IP connection and will try to (re)establish an IP connection when it is necessary and to close the connection when it is no longer necessary. In this case, the composition, the PPP and/or CPRS parameters must have been activated by the API TCP/IP before the connection to a message broker.

c—Return Values

MQISDP_OK: The initialisation (or reinitialisation) has ended.
   3.6.3) mgisdp Resume Function

This function must be called when an IP connection has been established after the MQIsdp library has indicated that an IP connection was necessary (MQISDP_LINK_NEEDED) by means of the connection processing program.

a—Prototype

void mqisdp_resume ( );

b—Parameters

None.

c—Return Values

None.

3.6.4) mqisdp Connect Function

This function is used to establish a connection with a message broker. The function is asynchronous and the final result of the operation is indicated by a recall function (ConCtrlHandler). If a connection is already active when this function is called, an error is sent.

a—Prototype

u8 mqisdp_connect (
mqisdp_connectionParams_t* ConnectionParams,
mqisdp_connectionOptions_t* ConnectionOptions,
mqisdp_connectionWill_t* Connection Will,
mqisdp_conCtrlHdlr_f* ConCtrlHandler,
mqisdp_msgCtrlHdlr_f* MsgCtrlHandler,
mqisdp_subCtrlHdlr_f* SubCtrlHandler,
mqisdp_msgHdlr_f* MsgHandler,
);

b—Parameters

* ConnectionParams: Link to a structure containing the basic connection information. The link does not have to have a null value; the structure uses the following type:

typedef struct
{
// Client id with a maximum length of 29
ascii*Clientid;
//Address of message broker (ip or name, according to the settings of the
TCP/IP stack)
ascii*BrokerAddress;
}
mqisdp_connectionParams_t;

* Connection Options:

Link to a structure containing optional connection information using the following type:

typedef struct
{
//Port on which to connect to the message broker
u16 Port;//default: 1883
//Keep Alive Timer; C=no keep-alive messages
u16 KeepAliveTimer;//default; 0
//Retry count; how many times a connection attempt or message sending
should be retried
u16 RetryCount”//default: 10
//Retry delay: how long the library should at least wait before retrying
(in seconds)
u16 RetryDelay;//default: 10
//Clean flag: indicates whether each client connection should be
performed or not!
bool nCleanConnection://default:TRUE
}
mqisdp_connectionOptions_t;

The link can have the null value (NULL). In this case, the default values are used.

* ConnectionWill:

Link to a structure containing the information on the connection will. The structure uses the following type:

typedef struct
{
//Quality of service
u8 Qos;
bool Retain;
ascii* Topic;
u18 PayloadLength;
u8 Payload [3];
}
mqisdp_connectionwill_t;

The link can have the null value (NULL). In this case, the default values are used.

* ConCtrlHandler:

Connection control processing program through which the client receives events relating to the connection. The processing program uses the following type:

typedefvoid (*mqisdp_conCtrlHdlr_f) (u8 Event, u8 Error Code);

The Event parameter can have the following values:
MQISDP_CON_OPEN: The connection to the broker is ready.
MQISDP_CON_ERR: The connection could not be established due to an error or was interrupted (the library can attempt to restore it).
MQISDP_CON_ACCEPTED: The mqisdp connection with the broker is ready.
MQISDP_CON_REFUSED: The mqisdp connection with the broker has been refused.
MQISDP_CON_IN_Q_FULL: Incoming data has been refused because the queue is full.
MQISDP_CON_BROKEN: The mqisdp connection with the broker has been interrupted and all reconnection attempts have failed.
MQISDP_CON_CLOSED: The connection with the broker has been closed (properly).
MQISDP_CON_DISCONNECTED: The mqisdp connection with the broker has been closed (properly).

In a normal scenario (from the connection to the disconnection), the control processing program receives the following sequence of events:

MQISDP_CON_OPEN

MQISDP_CON_ACCEPTED

MQISDP_CON_CLOSED

MQISDP_CON_DISCONNECTED

It is possible to send messages only when the MQIsdp connection is ready (i.e. when the MQISDP_CON_ACCEPTED function has been received and no disconnection has taken place or been performed.

The Errorcode parameter is used only if the Event parameter is MQISDP_CON_REFUSED. In this case, the error code can take the following forms:
MQISDP_ERR_PROTOCOL_VERSION_ERROR: Connection refused due to an unimplemented protocol version.
MQISDP_ERR_BROKER_UNAVAILABLE: Connection refused due to the unavailability of the broker.
MQISDP_TCPIP_UNAVAILABLE: The connection could not be established due to an error in the TCP/IP connection.
MQISDP_DNS_PROBLEM: The connection could not be established due to a SND error.
MQISDP_ERR_SOCKET_ERROR: The connection could not be established due to a socket error.
   * MsgCtrlHandler:

Message control processing program through which

the client receives events relating to the sending of the message. The processing program uses the following type:

typedef void (*mqisdp_msgCtrlHdlr_f) (u8 Event, u16 Msgid);

The Event parameter can take the following forms:
MQISDP_MSG_DELIVERED: The message has been sent/distributed (in accordance with the QoS parameter).
MQISDP_MSG_DISCARDED: The message has been discarded (failure of all attempts)

The Msgid parameter contains the id of the message affected by the event. The id of a message is sent when one of the following functions is used: mqisdp_publish, mqisdp_subscribe, mqisdp_unsubscribe, mqisdp_disconnect.

* SubCtrlHandler:

Subscription control processing program through which (if there is not a null value (NULL)) the client receives events relating to the acknowledgement of receipt of the subscription. If the processing program has a NULL value, the acknowledgement of receipt events are transferred to the message control processing program.

However, information relating to the quality of service level for each of the subscribed headers cannot be received by means of the message control processing program.

The subscription control processing program uses the following type:

typedef void (*mqisdp_subCtrolHdlr_f) (
u8 Event,
mqisdp_subscriptionParams_t* SubscriptionArray
);

The Event parameter can take the following forms:
MQISDP_MSG_DELIVERED: The message has been sent/distributed (in accordance with the QoS parameter).
MQISDP_MSG_DISCARDED: The message has been discarded (failure of all attempts)

The Msgid parameter contains the id of the message affected by the event. The id of the message is sent when the function mqisdp_subscribe is used.

The SubscriptionArray parameter is a table of elements with the following structure:

Typedef struct
{
ascii* Topic,
u8 QoS
}
mqisdp_subscriptionParams_t;

The table saves information on the quality of service level for each of the subscribed headers.

* MsgHandler:

Message processing program through which the client receives messages from the broker. The processing program uses the following type:

Typedef bool (*mqisdp_msgHdlr_f) (
Ascii * Topic,
Bool Retain,
Bool Duplicate,
mqisdp_qos_e QoS,
Mqisdp_messageid msgid,
U16 PayloadLength,
U8 Payload [1]
);

If the message processing program sends the True value, the library will suppress the Payload parameter. If not, the client must implement the payload management.

The parameter mqisdp_messageid is defined as follows:
Typedef u16 mqisdp_messageid;
The parameter mqisdp_qos_e is defined as follows
Typedef enum
{
MQISDP_QOS_0,
MQISDP_QOS_1,
MQISDP_QOS_2,
} mqisdp_qos_e

c—Return Values
MQISDP_OK: Success
MQISDP_ERR_Q_FULL: Queue for messages to be sent externally is too small/full.
MQISDP_ERR_ALREADY_CONNECTED: Already connected to a broker. Start by disconnecting.
MQISDP_ERR_DISCONNECT_PENDING: A disconnection is pending. Awaiting disconnection.
MQISDP_ERR_PARAM_CLIENT_ID: The client_id parameter is illegal.
MQISDP_ERR_PARAM_CLIENT_ID_TOO_BIG: The client_id parameter is too long (maximum 23 characters).
MQISDP_ERR_PARAM_TOPIC: The topic parameter is illegal.
MQISDP_ERR_PARAM_TOPIC_TOO_BIG: The topic parameter is too long (maximum 32 767 characters).
MQISDP_ERR_PARAM_DATA_LENGTH: The payload_length parameter is illegal.
MQISDP_ERR_PARAM_DATA_TOO_BIG: The payload parameter is too long (maximum 65 535 characters, including the headers).
MQISDP_ERR_PARAM_QOS: The qos parameter is incorrect.
MQISDP_PIN_NOT_ENTERED: An error due to missing PIN code has occurred.
   3.6.5) mqisdp Disconnect Function

This function is used to close the mqisdp connection. If it is called when another disconnection is pending, an error will be sent.

a—Prototype

u8 mqisdp_disconnect (
mqisdp_messageid* MsgId,
bool ImmediateDisconnect
);

b—Parameters
* Msgid:

In return, retains the id assigned to the disconnection message.

* ImmediateDisconnect:

This indicator determines whether the disconnection must be forced immediately (if the indicator has a True value) or if the disconnection can wait for all of the messages currently queuing have been distributed (or discarded). If the disconnection can wait, the library does not accept new messages from the broker.

c—Return Values

MQISDP_OK: Success.
MQISDP_ERR_DISCONNECT_PENDING: A disconnection is already pending.
   3.6.6) mqisdp Publish Function

This function is used to publish a MQIsdp message to the message broker. This operation can be performed only if a connection is already active.

a—Prototype

u8 mqisdp_publish (
mqisdp_messageId* MsgId,
ascii * Topic,
mqisdp_qos_e Qos,
bool Retain
u18 PayloadLength,
u8 Payload [1]
)

b—Parameters
* Msgid:

In return, retains the id assigned to the disconnection message.

c—Return Values

MQISDP_OK: Success.
MQISDP_ERR_CONNECTION_INVALID: The connection to the broker is not ready.
MQISDP_ERR_Q_FULL: The queue for messages to be sent externally is too small/full.
MQISDP_ERR_DISCONNECT_PENDING: A disconnection is pending. Unable to accept messages.
MQISDP_ERR_PARAM_TOPIC: The topic parameter is illegal.
MQISDP_ERR_PARAM_TOPIC_TOO_BIG: The topic parameter is too long (maximum 32 767 characters).
MQISDP_ERR_PARAM_DATA_LENGTH: The payload_length parameter is illegal.
MQISDP_ERR_PARAM_DATA_TOO_BIG: The payload parameter is too long (maximum 65 535 characters, including the headers).
MQISDP_ERR_PARAM_QOS: The qos parameter is incorrect.
   3.6.7) mqisdp Subscribe Function

This function is used to send a subscription message to the message broker. This operation can be performed only if a connection is already active.

a—Prototype

u8 mqisdp_subscribe
{
mqisdp_messageId* MsgId,
u16 NoOfSubscriptions,
mqisdp_subscriptionParams_t*
SubscriptionArray
}

b—Parameters
* Msgid:

In return, retains the id assigned to the disconnection message.

* NoOfSubscriptions:

Number of elements of the SubscriptionArray parameter.

* SubscriptionArray:

Table of elements with the following structure:

* Typedef struct

{
ascii * Topic
u8 QoS
}
mqisdp_subscriptionParams_t;

c—Return Values
MQISDP_OK: Success.
MQISDP_ERR_CONNECTION_INVALID: The connection to the broker is not ready.
MQISDP_ERR_Q_FULL: The queue for messages to be sent externally is too small/full.
MQISDP_ERR_DISCONNECT_PENDING: A disconnection is pending. Unable to accept messages.
MQISDP_ERR_PARAM_TOPIC: The topic parameter is illegal.
MQISDP_ERR_PARAM_TOPIC_TOO_BIG: The topic parameter is too long (maximum 32 767 characters).
MQISDP_ERR_PARAM_QOS: The qos parameter is incorrect.
   3.6.8) mqisdp Unsubscribe Function

This function is used to publish an unsubscription message to the message broker. This operation can be performed only if a connection is already active.

a—Prototype

u8 mqisdp_unsubscribe
{
mqisdp_messageId* MsgId,
u16 NoOfUnsubscriptions,
ascii * UnsubscriptionTopicAray
}

b—Parameters
* Msgid:

In return, retains the id assigned to the disconnection message.

* NoOfUnsubscriptions:

Number of elements of the UnsubscriptionArray parameter.

* UnsubscriptionArray:

Table of headers affected by the unsubscription.

c—Return Values

MQISDP_OK: Success.
MQISDP_ERR_CONNECTION_INVALID: The connection to the broker is not ready.
MQISDP_ERR_Q_FULL: The queue for messages to be sent externally is too small/full.
MQISDP_ERR_DISCONNECT_PENDING: A disconnection is pending. Unable to accept messages.
MQISDP_ERR_PARAM_TOPIC: The topic parameter is illegal.
MQISDP_ERR_PARAM_TOPIC_TOO_BIG: The topic parameter is too long (maximum 32 767 characters).
   3.6.9) mqisdp_getConStatus Function

This function is used to inquire about the connection status.

a—Prototype

u8 mqisdp_getConStatus ( );

b—Parameters

None

c—Return Values

MQISDP_CONNECTING: If a connection is being established (not yet ready to accept messages).
MQISDP_CONNECTED: If a connection is active (and ready to accept messages).
MQISDP_DISCONNECTED: No active connections.
   3.6.10) mqisdp_getMsgStatus Function

This function is used to inquire about the status of a given message.

a—Prototype

u8 mqisdp_getMsgStatus (mqisdp_messageid* MsgId);

b—Parameters

The identifier (id) of the message.

c—Return Values

MQISDP_IN_QUEUE: The message is in the queue to be sent externally (has not yet been sent).
MQISDP_SENDING: The message is now being sent (by TCP/IP).
MQISDP_IN_PROGRESS: The message has been sent by TCP/IP but no acknowledgement of receipt has been received.
MQISDP_NO_SUCH_MSG: The message does not exist (no longer exist). Either it was never sent, or it was sent and received (acknowledgement of receipt from the broker).
   3.6.11) mqisdp_setQueueSize Function

This function is used to define the size of the queue. The size of the queue can be modified at any time, but if the new size is too small to contain the current messages, an error is sent.

a—Prototype

u8 mqisdp_setQueueSize (u16 QueueSize);

b—Parameters

QueueSize: Size of the queue in octets.

c—Return Values

MQISDP_OK: Success.
MQISDP_ERR_Q_FULL: The queue cannot be defined. The parameter is clearly too small for the messages currently queuing.
   3.6.12) mqisdp getQueueSize Function

This function is used to determine the current size of the queue.

a—Prototype

u16 mqisdp_get QueueSize ( );

b—Parameters

None.

c—Return Values

The current size of the queue is sent (in octets).

3.6.13) mqisdp_getAvailableSize Function

This function is used to determine the amount of space available in the queue.

a—Prototype

u16 mqisdp_getAvailableSize ( );

b—Parameters

None.

c—Return Values

The space currently available in the queue is sent (in octets).

3.7) Example of an Embodiment

FIG. 3 shows an example of sending a message, using the PI function of the invention.

The steps are as follows:
initialisation 31: mqisdp_init function ( );
parameterisation 32 of the size of the queue: mqisdp_setqueuesize function ( );
TCP/IP connection 33 (opening of a GPRS session);
if the connection is not good (34): error message 35;
otherwise: connection 36 to the “broker”: mqisdp_connect function ( );
if the connection is not good (37): error message 35;
otherwise: sending of the message 38: mqisdp_publish function ( );
if disconnection 39, then end 310;
otherwise error message 35.

1. System for remote control of apparatuses, enabling the interconnection between at least one broker and at least one remote apparatus according to the MQIsdp protocol,
wherein the system associates, with at least one of said remote apparatuses, radiocommunication means capable of internally processing a communication protocol implementing API-type source functions available in a software platform (Open AT) enabling at least one application to be embedded, and
wherein said radiocommunication means are provided with a set of specific (API) functions enabling data to be exchanged with at least one server implementing said MQIsdp protocol,
so as to enable an interconnection between said at least one broker and said at least one remote apparatus via said radiocommunication means, with the latter also managing at least one application between said at least one broker and said at least one remote apparatus.

2. System for remote control of apparatuses according to claim 1, wherein said radiocommunication means include a radiocommunication module, grouping together on a single substrate all of the radiofrequency and baseband data processing means, as well as means for managing said (API) functions and said at least one application.

3. System for remote control of apparatuses according claim 1, wherein said radiocommunication means integrate said MQIsdp protocol in the form of a library, defining said set of specific (API) functions.

4. System for remote control of apparatuses according to claim 1, wherein at least in a first mode, said radiocommunication means manage only the signalling of a data exchange, with said data being transferred directly from a remote apparatus to a server, or the reverse.

5. System for remote control of apparatuses according to claim 1, wherein at least in a second mode, said radiocommunication means manage the signalling of a data exchange and the transfer of said data, with the latter being temporarily stored in at least one buffer storage.

6. System for remote control of apparatuses according to claim 5, wherein the size of said at least one buffer storage is parameterable.

7. System for remote control of apparatuses according to claim 6, wherein the system operates in said first mode when the size of said at least one buffer storage is 0, and in said second mode if not.

8. System for remote control of apparatuses according to claim 1, wherein said set of specific API functions includes functions enabling:
the connection to one of said at least one broker;
the sending of messages;
the receiving of messages;
configuration of at least one parameter.

9. System for remote control of apparatuses according to claim 1, wherein at least some of said specific (API) functions are organised so as to be capable of providing at least two operations and/or acting on at least two distinct aspects, according to a predefined parameterization.

10. System for remote control of apparatuses according to claim 1, wherein said set of (API) functions includes only 12 functions.

11. System for remote control of apparatuses according to claim 1, wherein said set of specific (API) functions includes an initialisation function (mqisdp_init) restoring default parameters, which must be called at least once before the use of other (API) functions.

12. System for remote control of apparatuses according to claim 1, wherein said set of specific (API) functions includes a function (mqisdp_resume) called when an IP connection has been established.

13. System for remote control of apparatuses according to claim 1, wherein the system includes a function of establishing a connection with one of said brokers (mqisdp_connect), making it possible to define parameters of said connection, and a function for disconnecting (mqisdp_disconnect) said connection.

14. System for remote control of apparatuses according to claim 13, wherein said function of establishing a connection makes it possible to select a transmission mode from at least two (GSM and GPRS).

15. System for remote control of apparatuses according to claim 1, wherein the system includes a function (mqisdp_publish) for sending a message to one of said brokers.

16. System for remote control of apparatuses according to claim 1, wherein the system includes a function for subscribing to one of said brokers (mqisdp_subscribe), and a function for unsubscribing (mqisdp_unsubscribe) to said broker.

17. System for remote control of apparatuses according to claim 1, wherein the system includes at least one function for requesting information on at least one aspect of a communication in progress.

18. System for remote control of apparatuses according to claim 17, wherein the system includes at least one of the functions belonging to the group including:
a function for inquiring about the status of a connection (mqisdp_getConStatus);
a function for inquiring about the status of a given message (mqisdp_getMsgStatus);
a function for inquiring about the current size of a queue (mqisdp_getQueueSize); and
a function for inquiring about the space available in a queue (mqisdp_getAvailableSize).

19. System for remote control of apparatuses according to claim 1, wherein the system includes a function for defining the size of a queue (mqisdp_setQueueSize).

20. Method for remote control of apparatuses, enabling the interconnection between at least one broker and at least one remote apparatus according to the MQIsdp protocol,
wherein the method associates, with at least one of said remote apparatuses, radiocommunication means capable of internally processing a communication protocol implementing API-type source functions available in a software platform (Open AT) enabling at least one application to be embedded,
and wherein the method implements, in said radiocommunication means, a set of specific API functions enabling data to be exchanged with at least one broker implementing said MQIsdp protocol,
so as to enable an interconnection between said at least one broker and said at least one remote apparatus via said radiocommunication means, with the latter also managing at least one application between said at least one broker and said remote apparatus.

21. A radiocommunication device comprising radiocommunication means implemented in a system for remote control of apparatuses according to claim 1.

22. A radiocommunication module comprising radiocommunication means implemented in a system for remote control of apparatuses according to claim 1.

23. A set of (API) functions implemented in a system for remote control of apparatuses, wherein the set enables data to be exchanged with at least one broker implementing an MQIsdp protocol.
